(19) United States
(12) Patent Application Publication
(10) Pub. No.: US 2018/0048581 A1
(43) Pub. Date: Feb. 15, 2018

(54) COMMUNICATION APPARATUS AND COMMUNICATION METHOD

(71) Applicant: FUJITSU LIMITED, Kawasaki-shi (JP)

(72) Inventor: Junichi SUGA, Ota (JP)

(73) Assignee: FUJITSU LIMITED, Kawasaki-shi (JP)

(21) Appl. No.: 15/653,114

(22) Filed: Jul. 18, 2017

(30) Foreign Application Priority Data
Aug. 9, 2016 (JP) 2016-156248

(51) Int. Cl. H04L 12/807; H04L 29/08; H04L 12/813; H04L 29/06

(52) U.S. Cl. CPC H04L 47/27; H04L 69/16; H04L 67/14; H04L 47/20

(57) ABSTRACT

A communication apparatus includes a memory and a processor coupled to the memory. The processor is configured to receive application information on respective first and second applications from a terminal apparatus. The first and second applications are executed in the terminal apparatus. The processor is configured to control first and second communication bands for respective first and second communication sessions on basis of the received application information. The first and second communication sessions correspond to the respective first and second applications.

### CROSS-REFERENCE TO RELATED APPLICATION

This application is based upon and claims the benefit of priority of the prior Japanese Patent Application No. 2016-156248, filed on Aug. 9, 2016, the entire contents of which are incorporated herein by reference.

### FIELD

The embodiments discussed herein are related to a communication apparatus and a communication method.

### BACKGROUND

Currently, in the 3rd Generation Partnership Project (3GPP), which is a standardization organization, a succeeding system of Long Term Evolution (LTE) and LTE-Advanced has been examined as a technique of a large-capacity and high-speed wireless network system. Such a system is called the 5th Generation mobile communication (5G). In Japan, a service using carrier aggregation (CA), which is one kind of the LTE-Advanced technique, has been introduced in earnest since 2015. Wireless communication may be performed at transmission speed exceeding 200 Mbps.

In the field of the wireless communication, a technique of mobile edge computing (MEC) is attracting attention. The MEC is a technique for, for example, equipping computing resources, a storage, and the like to a communication apparatus installed near a terminal apparatus, and providing communication applications and server applications via the communication apparatus. Consequently, for example, it is possible to provide high-response communication to the terminal apparatus and also reduce network traffic.

On the other hand, a technique of congestion control is sometimes used for communication. The congestion control is a technique for, for example, adjusting a congestion window equivalent to a transmission amount of packets. For example, when the congestion control is applied to a Transmission Control Protocol (TCP), a communication session (hereinafter sometimes referred to as “TCP session”) by the TCP is established every time a service such as a Web browsing service is executed. The congestion control is performed for each of the TCP sessions. With the congestion control, for example, it is possible to reduce occurrence of congestion in communication performed via the TCP session.

As such a technique for communication, for example, there is a technique related to an application server that is arranged on an access network device side and is independent of the access network device or in the device and that receives a service packet transmitted from the device and operates at least one service. According to the technique, it is possible to greatly improve a response time to a user request to reduce a service delay, improve Quality of Service (QoS) of a service, and improve user experience.

Related techniques are disclosed in, for example, Japanese National Publication of International Patent Application No. 2014-531838.

Communication resources usable in one communication line are limited. Therefore, when multiple TCP sessions are generated in the communication line, a certain TCP session sometimes affects another TCP session.

For example, there is a case where a terminal apparatus executes, as a system, a certain application (for example, update of an application program) and a TCP session for the application occupies more communication resources than other TCP sessions. Thereafter, when the terminal apparatus (or a user) executes an application for video viewing, communication resources of a TCP session for the application for video viewing are restricted by occupation of communication resources by the application executed as the system. In this case, the throughput of the TCP communication for the application for video viewing is so low that sensory quality of the user is deteriorated.

In the technique related to the application server that is arranged on the access network device side and operates at least one service, a method of coping with multiple TCP sessions has not been discussed at all. Therefore, with this technique, the sensory quality of the user is deteriorated in some cases.

### SUMMARY

According to an aspect of the present invention, provided is a communication apparatus including a memory and a processor coupled to the memory. The processor is configured to receive application information on respective first and second applications from a terminal apparatus. The first and second applications are executed in the terminal apparatus. The processor is configured to control first and second communication bands for respective first and second communication sessions on basis of the received application information. The first and second communication sessions correspond to the respective first and second applications.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a communication system;

FIG. 2 is a diagram illustrating an exemplary functional configuration of a terminal apparatus;

FIG. 3 is a diagram illustrating an exemplary functional configuration of an MEC server;

FIG. 4A is a diagram illustrating an example of application information, FIG. 4B is a diagram illustrating an example of communication information, and FIG. 4C is a diagram illustrating an example of MEC server notification information;

FIG. 5 is a diagram illustrating an exemplary configuration of a packet for transmitting the MEC server notification information;

FIG. 6 is a diagram illustrating an example of terminal communication management information;

FIG. 7 is a diagram illustrating an example of a policy table;

FIG. 8 is a flowchart illustrating an exemplary flow of a process for updating the terminal communication management information;

FIG. 9 is a flowchart illustrating an exemplary flow of a process for adjusting congestion windows;

FIG. 10 is a flowchart illustrating an exemplary flow of a process for adjusting congestion windows;

FIG. 11 is a flowchart illustrating an exemplary flow of a process for adjusting congestion windows;

FIGS. 12A to 12C are diagrams illustrating an example of congestion window values;

FIGS. 13A to 13C are diagrams illustrating an example of congestion window values;

FIGS. 14A to 14C are diagrams illustrating an example of congestion window values;

FIG. 15A is a diagram illustrating an example of MEC server notification information, and FIG. 15B is a diagram illustrating an example of terminal communication management information;

FIG. 16 is a diagram illustrating an exemplary hardware configuration of the terminal apparatus and the MEC server; and

FIG. 17 is a diagram illustrating an exemplary functional configuration of the communication system.

### DESCRIPTION OF EMBODIMENTS

Embodiments are described below. Note that the embodiments described below do not limit a technique disclosed herein. In particular, the technique of this application is applicable to different expressions if the expressions are technically equivalent. The different expressions do not limit the scope of rights. The embodiments may be combined as appropriate in a range in which contradiction of processing contents is not caused. As terms used and technical contents described in this specification, terms and technical contents described in specifications as standards for communication such as 3GPP may be used as appropriate.

### First Embodiment

A first embodiment is described.

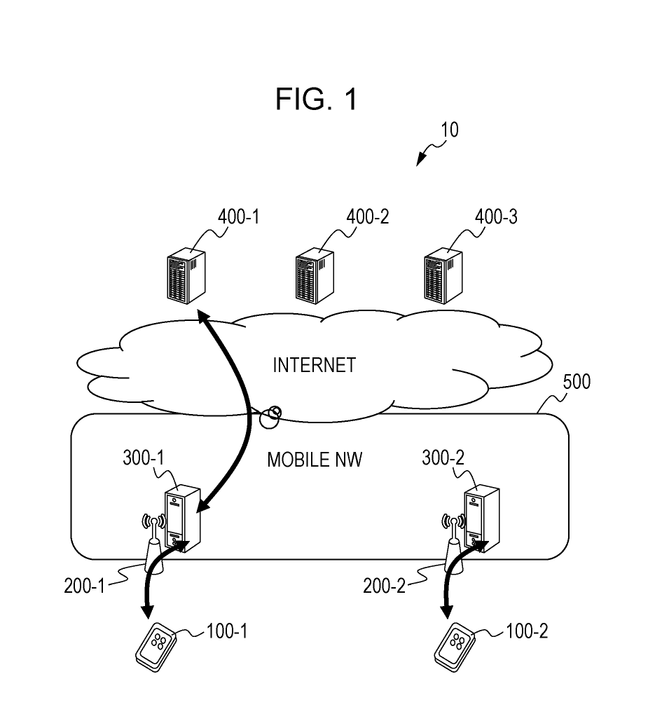

FIG. 1 is a diagram illustrating an exemplary configuration of a communication system 10. The communication system 10 includes terminal apparatuses 100-1 and 100-2 (hereinafter sometimes referred to as “terminals”), base station apparatuses 200-1 and 200-2 (hereinafter sometimes referred to as “base stations”), MEC servers 300-1 and 300-2, and server apparatuses 400-1 to 400-3 (hereinafter sometimes referred to as “servers”).

Note that the MEC servers 300-1 and 300-2 may be included in the base stations 200-1 and 200-2, respectively. In the communication system 10 illustrated in FIG. 1, an example is illustrated in which the MEC servers 300-1 and 300-2 are arranged near the base stations 200-1 and 200-2 and coupled to the base stations 200-1 and 200-2, respectively. As illustrated in FIG. 1, the base stations 200-1 and 200-2 and the MEC servers 300-1 and 300-2 are coupled to a mobile network (NW) 500.

The terminals 100-1 and 100-2 are communication apparatuses (or wireless communication apparatuses) such as feature phones, smartphones, tablet terminals, gaming devices, or the like. The terminals 100-1 and 100-2 are capable of receiving provision of various services such as a call service and a Web browsing service in serviceable ranges (or cell ranges) of the base stations 200-1 and 200-2.

The base stations 200-1 and 200-2 are communication apparatuses (or wireless communication apparatuses) that perform wireless communication with the terminals 100-1 and 100-2 in their own serviceable ranges. The base stations 200-1 and 200-2 are respectively coupled to the MEC servers 300-1 and 300-2. The base stations 200-1 and 200-2 respectively exchange data and the like with the MEC servers 300-1 and 300-2 and the terminals 100-1 and 100-2.

The MEC servers 300-1 and 300-2 deliver contents stored in internal storages or the like to the terminals 100-1 and 100-2, for example, in response to requests from the terminals 100-1 and 100-2.

In the example illustrated in FIG. 1, the MEC server 300-1 acquires contents corresponding to the request from the server 400-1 and delivers the acquired contents to the terminal 100-1. In this case, the MEC server 300-1 establishes a communication session (hereinafter sometimes referred to as “TCP session”) by the TCP with the server 400-1 to acquire the contents and establishes another TCP session with the terminal 100-1 to deliver the contents. Therefore, the MEC server 300-1 plays a role of a TCP proxy.

On the other hand, in the example, the MEC server 300-2 has contents corresponding to the request from the terminal 100-2 in a storage thereof. The MEC server 300-2 reads out the contents from the storage and delivers the read out contents to the terminal 100-2. In this case, the MEC server 300-2 establishes a TCP session with the terminal 100-2 and delivers the contents by using the TCP session.

Note that the communication session or the session represents, for example, a start to an end of communication in a transport layer protocol. The TCP session represents, for example, a communication session in which a TCP protocol is used as the transport layer protocol. When a TCP session is established between apparatuses, a TCP packet may be transmitted between the apparatuses. Between the same pair of apparatuses, different TCP sessions may be established for respective different services such as a Web browsing service and an electronic mail service. Therefore, the TCP session may also be considered, for example, a start to an end of communication of a different TCP packet depending on a service.

The servers 400-1 to 400-3 are servers that provide services to the terminals 100-1 and 100-2, such as Web delivery servers or video contents delivery servers. The servers 400-1 to 400-3 may be disposed for each of services; for example, the server 400-1 is a Web delivery server and the server 400-2 is a video contents delivery server.

Note that, in the following description, unless specifically noted otherwise, in some cases, the terminals 100-1 and 100-2 are referred to as terminals 100, the base stations 200-1 and 200-2 are referred to as base stations 200, the MEC servers 300-1 and 300-2 are referred to as MEC servers 300, and the servers 400-1 to 400-3 are referred to as servers 400.

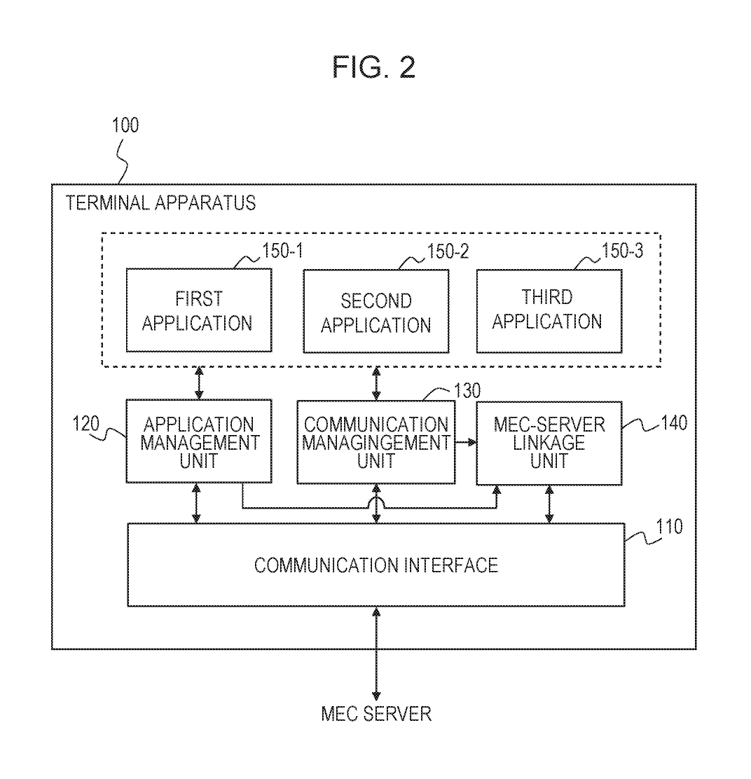

FIG. 2 is a diagram illustrating an exemplary functional configuration of the terminal 100. The terminal 100 includes a communication interface 110, an application management unit 120, a communication management unit 130, and a MEC-server linkage unit 140. Note that, in the terminal 100 illustrated in FIG. 2, an example is illustrated in which three applications (applications 150-1 to 150-3) are executed on an operating system (OS).

Note that, in the following description, the applications 150-1 to 150-3 are executed by a processor such as a central processing unit (CPU) of the terminal 100 via the OS. The applications 150-1 to 150-3 are sometimes referred to as being executed on the OS.

The communication interface 110 establishes, for example, in accordance with instructions from the communication management unit 130, TCP sessions for the applications 150-1 to 150-3 with the MEC servers 300 and the servers 400 (hereinafter sometimes referred to as “external servers”). The communication interface 110 exchanges TCP packets with the external servers by using the TCP sessions.

The application management unit 120 manages the applications 150-1 to 150-3 executed in the terminal 100. For example, the application management unit 120 receives, via the communication interface 110, an application program received from an external server and performs, on the application program, distribution of resources such as a CPU resource and a memory. The application management unit 120 causes the OS (or the CPU; in the following description, the OS and the CPU are sometimes not distinguished) to execute the program using the distributed resources to execute the applications 150-1 to 150-3.

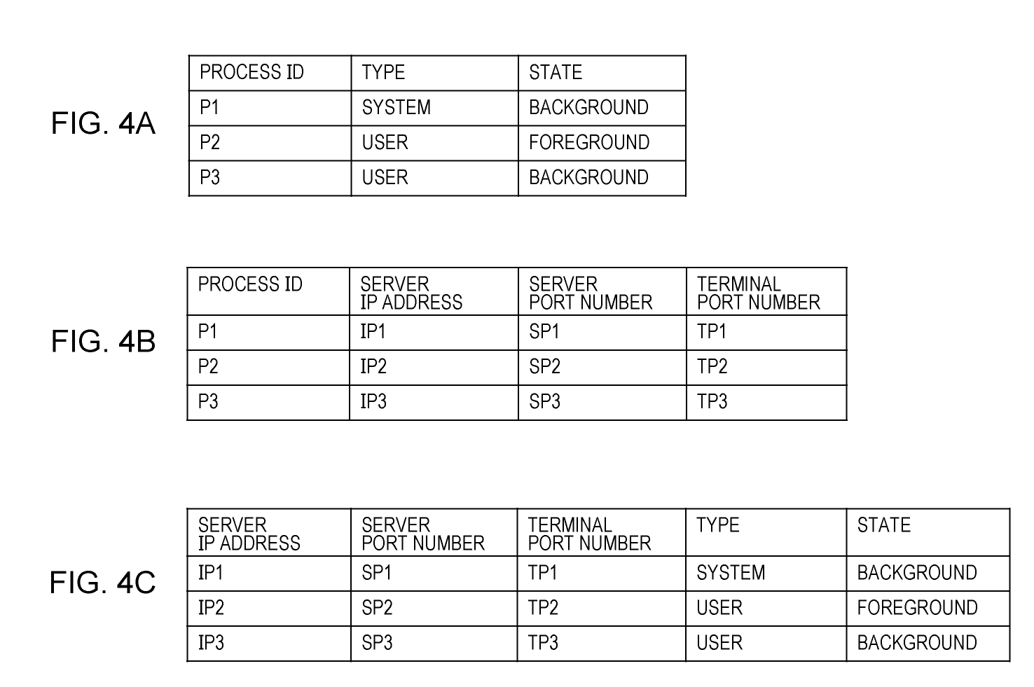

The application management unit 120 manages application information. FIG. 4A illustrates an example of the application information. The application information includes information on types and states of the applications 150-1 to 150-3 and process identifiers (IDs).

As the types of the applications 150-1 to 150-3, there are, for example, a user application and a system application. The user application represents, for example, an application executed by operating the terminal 100 by a user himself or herself. Applications such as Web browsing and video viewing are examples of the user application. On the other hand, the system application represents, for example, an application automatically executed by a system. An application for automatically updating a program or automatically updating the OS is an example of the system application. The system application may also be referred to as, for example, an application that is automatically executed without operating the terminal 100 by the user.

The states (or execution states) of the applications 150-1 to 150-3 respectively represent, for example, whether the applications 150-1 to 150-3 are executed in the foreground or in the background.

For example, in the terminal 100 with a multitask environment, when multiple applications are displayed on a screen of the terminal 100, an active application present at the foremost position on the screen and operable by the user is a foreground application. For example, other applications executed in the terminal 100 are background applications.

When the terminal 100 is a smartphone or the like, the application 150-1 displayed on the screen of the terminal 100 is a foreground application and the application 150-2 executed without being displayed on the screen is a background application.

The application management unit 120 acquires application information, for example, as described below. That is, when the application management unit 120 causes the OS to execute an application program acquired from the communication interface 110, the OS allocates process IDs in the order of start of the applications 150-1 to 150-3. When executing the applications 150-1 to 150-3, the OS may identify, depending on an operation or the like on the terminal 100 by the user, whether the applications 150-1 to 150-3 are user applications or system applications or whether the applications 150-1 to 150-3 are foreground applications or background applications. The application management unit 120 may acquire, from the OS, the process IDs and information on whether the applications 150-1 to 150-3 are user applications or system applications or whether the applications 150-1 to 150-3 are foreground applications or background applications. Consequently, the application management unit 120 may acquire, for example, the application information illustrated in FIG. 4A.

Referring back to FIG. 2, the application management unit 120 outputs the application information to the MEC-server linkage unit 140.

The communication management unit 130 manages communication between the terminal 100 and the MEC server 300. Specifically, the communication management unit 130 performs, for example, management of communication information, communication control, and buffer management for communication. For example, the communication management unit 130 may also instruct the communication interface 110 to establish TCP sessions for the applications 150-1 to 150-3.

FIG. 4B illustrates an example of the communication information. The communication information includes, for example, an Internet protocol (IP) address and a port number of an external server, and a port number of the terminal 100. These kinds of information are, for example, information used by the MEC server 300 to identify TCP sessions in the terminal 100. The communication management unit 130 acquires the communication information, for example, as described below.

That is, when the communication interface 110 acquires data on an application program from an external server, the communication management unit 130 acquires, from the communication interface 110, an IP address, a port number, and the like of the external server serving as the source of the data. Thereafter, when the application program is executed by the OS, the communication management unit 130 may acquire a process ID from the OS. Thus, the communication management unit 130 may acquire, for example, the communication information illustrated in FIG. 4B by associating the process ID and the IP address, the port number, and the like of the external server.

Referring back to FIG. 2, the communication management unit 130 outputs the communication information to the MEC-server linkage unit 140.

The MEC-server linkage unit 140 receives the application information from the application management unit 120, receives the communication information from the communication management unit 130, and generates MEC server notification information on the basis of the application information and the communication information.

FIG. 4C illustrates an example of the MEC server notification information. The MEC server notification information includes the IP address and the port number of the external server, the port number of the terminal 100, and the information on the types and the states of the applications 150-1 to 150-3. The MEC-server linkage unit 140 may acquire the MEC server notification information by associating the application information and the communication information having the same process ID. Note that the process ID is not included in the MEC server notification information. This is because, for example, the MEC server 300 only has to be able to identify the TCP sessions for the respective applications 150-1 to 150-3 executed in the terminal 100 and does not have to identify the applications 150-1 to 150-3 by using the process IDs.

Referring back to FIG. 2, the MEC-server linkage unit 140 outputs the MEC server notification information to the communication interface 110 to transmit the MEC server notification information to the MEC server 300.

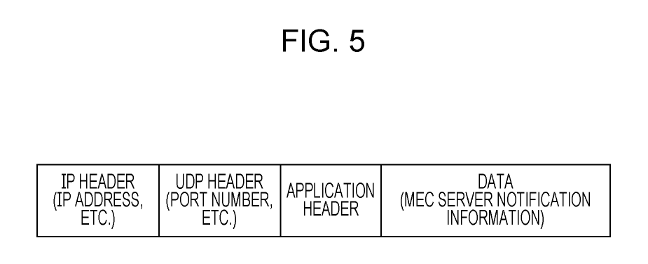

FIG. 5 illustrates an exemplary configuration of a packet including the MEC server notification information. An IP header includes an IP address of the MEC server, and the like. A User Datagram Protocol (UDP) header includes a port number of the MEC server, and the like. Further, the packet includes an application header. Information (or a flag) indicating that the MEC server notification information is included in the packet is inserted into the application header. The MEC server notification information is inserted into a data region of the packet. Upon receiving the MEC server notification information from the MEC-server linkage unit 140, the communication interface 110 generates a UDP packet illustrated in FIG. 5 by adding the headers and the like to the MEC server notification information. The communication interface 110 transmits the generated packet to the MEC server 300 via the base station 200.

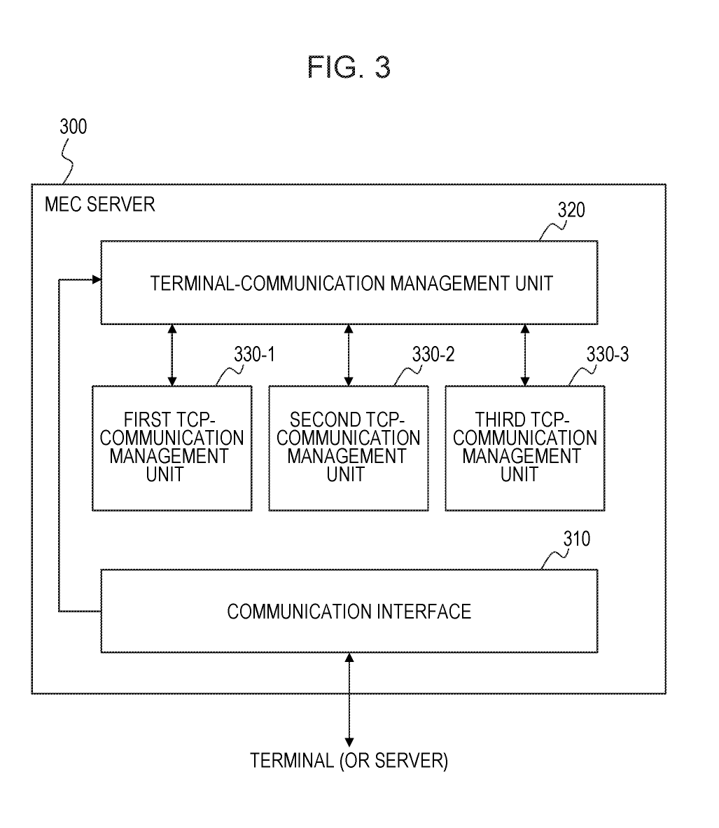

FIG. 3 is a diagram illustrating an exemplary functional configuration of the MEC server 300. The MEC server 300 includes a communication interface 310, a terminal-communication management unit 320, and TCP-communication management units 330-1 to 330-3.

The communication interface 310 establishes TCP sessions with the terminals 100, for example, in accordance with instructions from the TCP-communication management units 330-1 to 330-3 and exchanges TCP packets with the terminals 100 by using the TCP sessions. For example, upon receiving a TCP packet including MEC server notification information transmitted from a terminal 100 by using a TCP session, the communication interface 310 extracts the MEC server notification information from the TCP packet and outputs the extracted MEC server notification information to the terminal-communication management unit 320.

The communication interface 310 may establish TCP sessions with the servers 400, for example, in accordance with instructions from the TCP-communication management units 330-1 to 330-3 and exchange TCP packets by using the TCP sessions.

The terminal-communication management unit 320 performs communication management of the entire terminal 100, for example, based on the MEC server notification information. In the first embodiment, the terminal-communication management unit 320 controls, based on the application information included in the MEC server notification information, respective communication bands of the TCP sessions for the applications 150-1 to 150-3 executed in the terminal 100. Details are described later with reference to exemplary flows.

The TCP-communication management units 330-1 to 330-3 manage, for example, in cooperation with the terminal-communication management unit 320, a TCP session (or TCP communication; hereinafter sometimes referred to as “TCP session”) generated between the terminal 100 and the MEC server 300. In the example illustrated in FIG. 3, three TCP sessions are generated between the terminal 100 and the MEC server 300. Therefore, the MEC server 300 includes three TCP-communication management units 330-1 to 330-3.

For example, one TCP session corresponds to one of the applications 150-1 to 150-3 executed in the terminal 100. The application 150-1 executed in the terminal 100 may communicates a TCP packet with the MEC server 300 by using one TCP session. The TCP-communication management unit 330-1 manages the TCP session. Similarly, the TCP-communication management units 330-2 and 330-3 respectively manage TCP sessions for the applications 150-2 and 150-3 executed in the terminal 100.

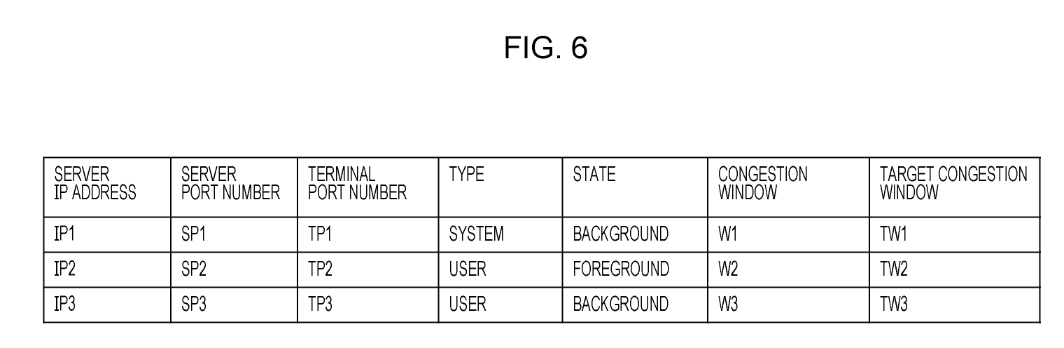

FIG. 6 illustrates an example of terminal communication management information. In the terminal communication management information, a “congestion window” and a “target congestion window” are added to the MEC server notification information.

The “congestion window” is, for example, a parameter value equivalent to a transmission rate of transmission data and represents a value for limiting a transmittable size of a TCP packet. The “congestion window” is, for example, a parameter value actually used for TCP control for each of the TCP sessions and represents a communication band in which transmission is possible in the TCP session.

The “target congestion window” is, for example, a parameter value set upon reception of the MEC server notification information, and represents a target value (or a target communication band) of a congestion window in respective TCP sessions.

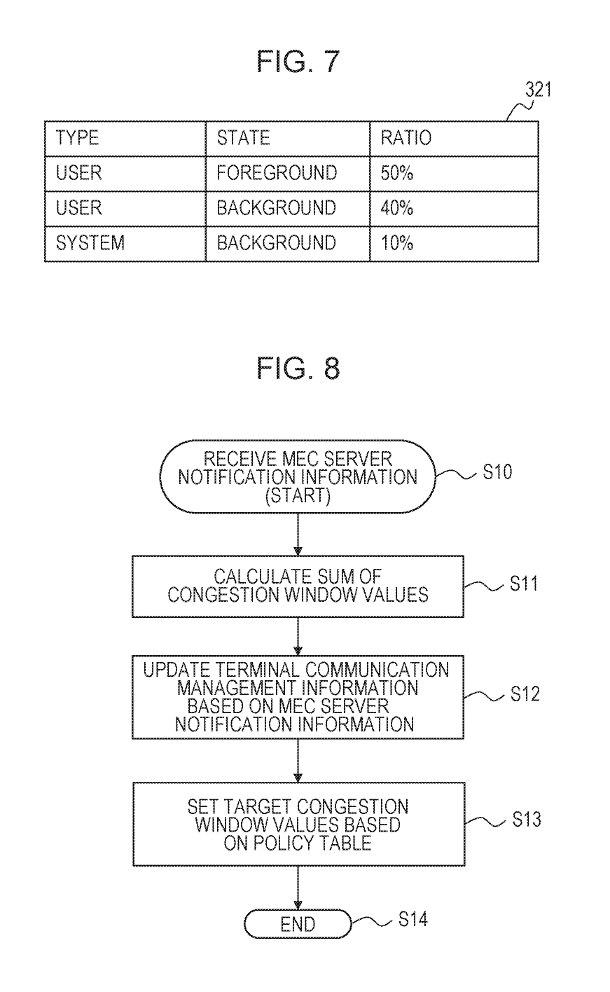

FIG. 7 illustrates an example of a policy table 321. The policy table 321 includes a “type” and a “state” of the applications 150-1 to 150-3, and a “ratio” that may be set depending on the type and the state. The “ratio” represents, for example, a “ratio” for setting (distributing) the target congestion window value for a combination of the “type” and the “state”.

For example, in the example illustrated in FIG. 7, the “ratio” for the combination that a “user application” is executed in the “foreground” is “50%”. The “ratio” for the combination that the “user application” is executed in the “background” is “40%”. The “ratio” for the combination that the “system application” is executed in the “background” is “10%”. The “target congestion windows” of the terminal communication management information illustrated in FIG. 6 are set in accordance with such ratios. That is, “TW1”:“TW2”:“TW3”=10%:50%:40%.

Note that, the “ratio” of the policy table 321 illustrated in FIG. 7 is an example. Other ratios may be set in accordance with, for example, a policy of the system. For example, among system applications, the applications 150-1 to 150-3 for security are important. Therefore, for example, the ratios of the applications 150-1 to 150-3 may be increased while reducing the other ratios.

For example, upon receiving the MEC server notification information, the terminal-communication management unit 320 sets a target congestion window values on the basis of the policy table 321 to update the terminal communication management information. For example, the policy table 321 and the terminal communication management information are stored in a memory or the like in the terminal-communication management unit 320. The terminal-communication management unit 320 performs, using the terminal communication management information, processing for bringing congestion window values of multiple TCP sessions close to the target congestion window values as a whole while adjusting the congestion window values. For example, when an application such as the “user application” executed in the “foreground” is prioritized, the congestion window value of the application may be set larger than congestion window values of other applications. Consequently, for example, the throughput of the application, which is executed by the user in the terminal 100, increases. Thus, sensory quality of the user may be improved.

Exemplary flows are described below.

An exemplary flow of a process for updating terminal communication management information (for example, FIG. 6) is described first. Then, an exemplary flow of a process for adjusting congestion windows on the basis of the terminal communication management information is described.

FIG. 8 illustrates the exemplary flow of the process for updating terminal communication management information. The process illustrated in FIG. 8 is performed by, for example, the terminal-communication management unit 320 of the MEC server 300. Note that, it is assumed that the TCP-communication management units 330-1 to 330-3 manage TCP sessions respectively corresponding to the applications (the applications 150-1 to 150-3; hereinafter sometimes referred to as “applications 150”) executed in the terminal 100 to perform TCP communication.

The MEC server 300 starts the process upon receiving MEC server notification information (S10). For example, the terminal-communication management unit 320 starts the process upon receiving the MEC server notification information from the communication interface 310.

Subsequently, the MEC server 300 calculates a sum of congestion window values (S11). For example, the terminal-communication management unit 320 calculates a sum of the “congestion window” for the respective TCP sessions in the terminal communication management information upon receiving the MEC server notification information. In the example illustrated in FIG. 6, the terminal-communication management unit 320 calculates “W1”+“W2”+“W3”.

Referring back to FIG. 8, subsequently, the MEC server 300 updates a relevant part of the terminal communication management information on the basis of the MEC server notification information (S12). For example, the “state” of the TCP session with “IP2”, “SP2”, “TP2”, and “user” is “foreground” in the example illustrated in FIG. 6. However, the received MEC server notification information may indicate the “state” of the relevant TCP session as “background”, since the MEC server notification information is sometimes changed by operation on the terminal 100 by the user. In such a case, the “state” of the relevant TCP session may be updated from “foreground” to “background”. Also, there may be case in which the “state” of a TCP session is updated from “background” to “foreground”. In the following, the description is given on the assumption that FIG. 6 illustrates the terminal communication management information after the update.

Referring back to FIG. 8, subsequently, the MEC server 300 sets target congestion windows on the basis of the policy table 321 (S13). For example, the terminal-communication management unit 320 sets, based on the policy table 321 illustrated in FIG. 7, {(“W1”+“W2”+“W3”)×10%} in the target congestion window (TW1) with respect to the application 150 of “system” type and “background” state in the terminal communication management information illustrated in FIG. 6. The terminal-communication management unit 320 sets {(“W1”+“W2”+“W3”)×50%} in the target congestion window (TW2) with respect to the application 150 of “user” type and “foreground” state.

Note that, in some cases, some of the combinations in the policy table 321 are not included in the terminal communication management information. In such a case, the terminal-communication management unit 320 only has to calculate the target congestion window values on the basis of a sum of ratios of the other combinations. For example, when a combination of the type “user” and the state “background” is not included in the terminal communication management information, the terminal-communication management unit 320 calculates a sum “60%” of the ratio “50%” of the combination of the type “user” and the state “foreground” and the ratio “10%” of the combination of the type “system” and the state “background”. The terminal-communication management unit 320 may convert the calculated sum “60%” into “100%” and calculate {(“W1”+“W2”+“W3”)×50/60} for the combination of the type “user” and the state “foreground”.

In some cases, two or more applications 150 with the same combination of “type” and “state” are included in the terminal communication management information. In this case, the terminal-communication management unit 320 may split the target congestion window value for the combination to be equally distributed to these applications 150.

The MEC server 300 terminates the process (S14). For example, the terminal-communication management unit 320 generates terminal communication management information in which the target congestion windows are updated as illustrated in FIG. 6. For example, the terminal-communication management unit 320 stores the terminal communication management information after the update in the memory or the like.

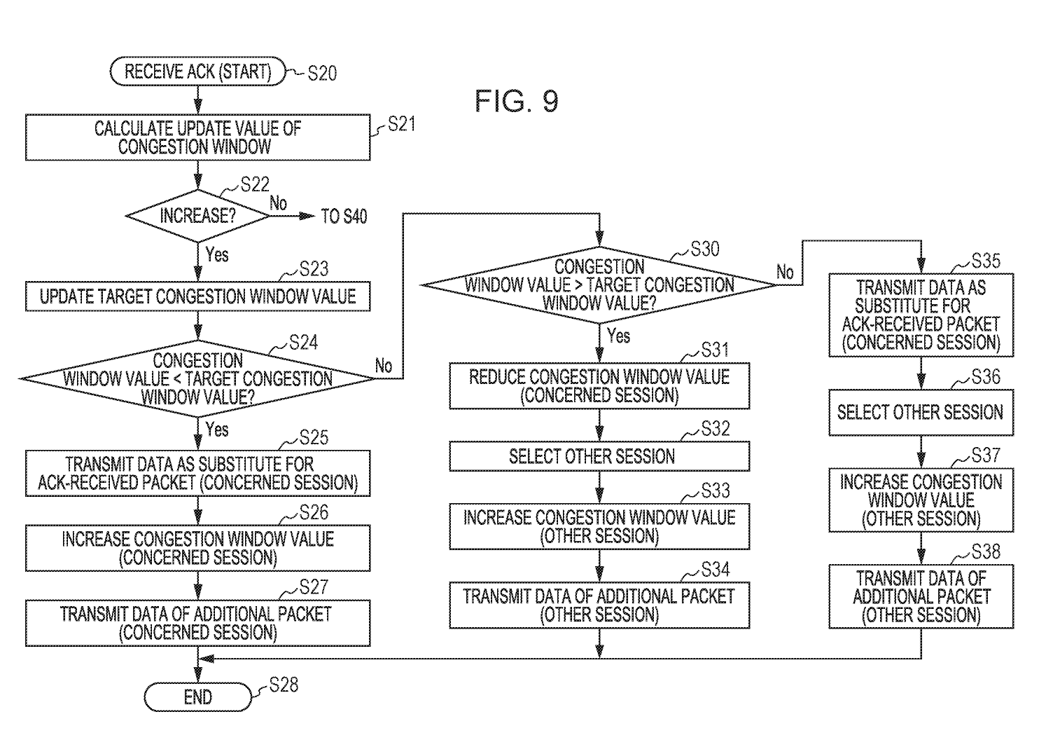

FIGS. 9 to 11 are flowcharts illustrating an exemplary flow of the process for adjusting congestion windows. As described above, the MEC server 300 performs the adjustment for bringing the congestion windows of the TCP sessions close to the target congestion windows while cooperating with the TCP sessions.

The MEC server 300 starts the process upon receiving an ACK signal (a response signal for reception acknowledgement; hereinafter sometimes referred to as “ACK”) in any one of the TCP sessions (S20). The process is started with the ACK reception as a trigger because, for example, in the congestion control of the TCP, update of a congestion window value is performed with the ACK reception as a trigger. For example, the terminal-communication management unit 320 starts the process upon receiving ACK from the terminal 100 via the communication interface 110.

Subsequently, the MEC server 300 calculates an update value W′ for a congestion window (S21). For example, the terminal-communication management unit 320 calculates, in accordance with a congestion control algorithm of the TCP, the update value W′ for a congestion window of the TCP session (referred to as an ACK-received TCP session) in which the ACK is received. The update value W′ is, for example, “+10”, “−10”, or the like. The update value W′ is, for example, a value of an increment or a decrement (or a value that neither increases nor decreases) with respect to the congestion window value before the update. Note that the terminal-communication management unit 320 only calculates the update value W′ and does not perform update of the congestion window value in this processing. The terminal-communication management unit 320 updates the congestion window value in S27, S31, S33, S35, S37, or the like in a later stage.

Subsequently, the MEC server 300 determines whether the calculated update value of the congestion window indicates an increase (S22). In the congestion control of the TCP, for example, when a transmission side confirms with reception of ACK that a TCP packet is transmitted to a transmission destination, the transmission side determines that congestion has not occurred and increases a congestion window value by a predetermined increment to improve throughput. For example, the MEC server 300 performs processing described below.

The terminal-communication management unit 320 notifies the ACK reception to the TCP-communication management unit 330 corresponding to the ACK-received TCP session. The TCP-communication management unit 330 calculates the update value W′ for the congestion window in accordance with the TCP congestion control algorithm and notify the update value W′ to the terminal-communication management unit 320. Thus, the terminal-communication management unit 320 may determine based on the received update value W′ whether the update value W′ indicates an increase.

Upon determining that the update value W′ for the congestion window indicates an increase (Yes in S22), the MEC server 300 updates the target congestion window values (S23). Due to the increase in the congestion window value of the TCP session, a sum of congestion window values of all the TCP sessions also increases. For example, the terminal-communication management unit 320 updates the target congestion window values on the basis of the increasing update value W′. In the update of the target congestion window values, as in the case of the target congestion window values in the terminal communication management information (for example, S12 and S13 in FIG. 8), the update value W′ for the congestion window calculated in S21 is distributed on the basis of the “ratio” of the policy table 321. For example, when an increment of the congestion window value calculated in S21 is “+10”, the update value W′ is “10”×“50%”=“5” for a TCP session of “user” and “foreground” and “10”×“40%”=“4” for a TCP session of “user” and “background”. The terminal-communication management unit 320 increases the “target congestion window values” in the terminal communication management information by the increments. For example, a target congestion window of “user” and “foreground” increases to “TW2+5%, a target congestion window of “user” and “background” increases to “TW3+4”, and a target congestion window of “system” and “background” increases to “TW1+1”.

Subsequently, the MEC server 300 determines whether the congestion window value is smaller than the target congestion window value after the update (S24). For example, the terminal-communication management unit 320 compares the congestion window value of the ACK-received TCP session in S20 and the target congestion window value after the update in the TCP session in S23 to make the determination.

The MEC server 300 performs processing in S25 to S27 when the congestion window value is smaller than the target congestion window value after the update (Yes in S24).

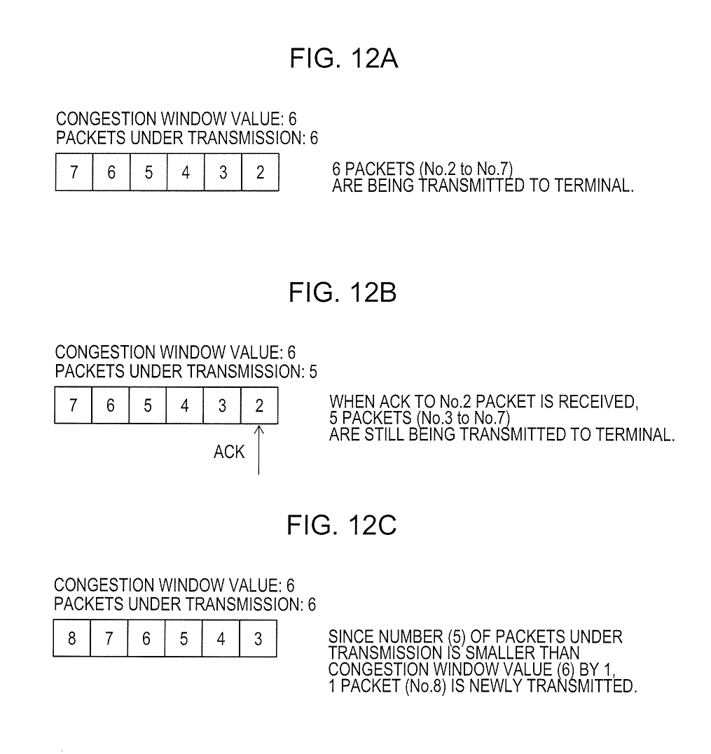

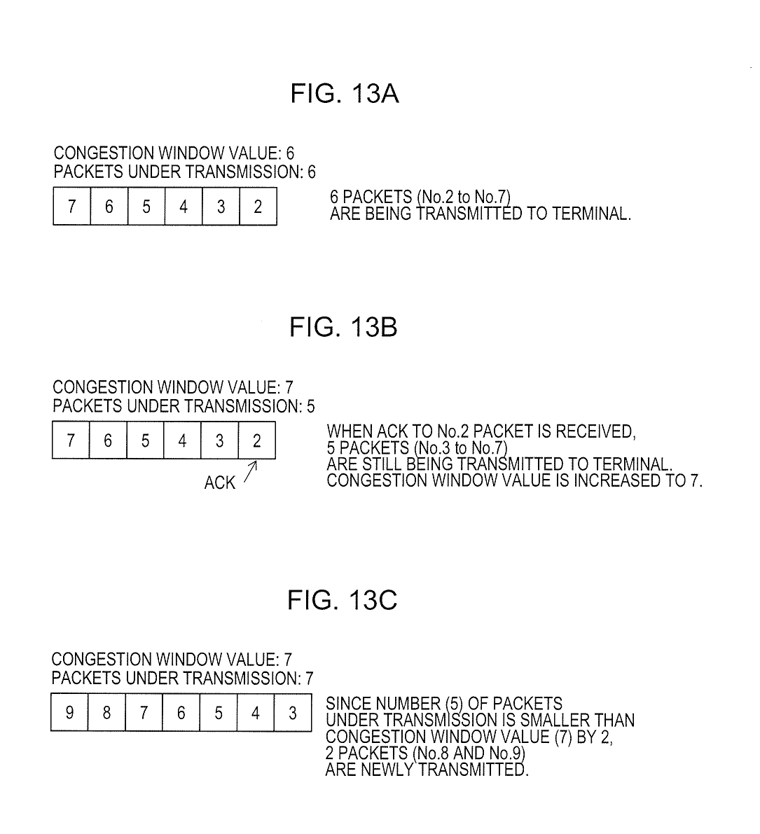

In order to describe the processing in S25 to S27, as specific examples, examples illustrated in FIGS. 12A to 13C are described. FIGS. 12A to 13C illustrate examples of a relation between congestion window values and packets.

FIGS. 12A to 12C illustrate an example in which the congestion window value is not changed. As illustrated in FIG. 12A, it is assumed that the congestion window value is “6” and the MEC server 300 transmits six packets of No. 2 to No. 7 to the terminal 100. In this case, when the MEC server 300 receives ACK for the No. 2 packet, the five packets of No. 3 to No. 7 are still being transmitted to the terminal 100 (FIG. 12B). Since the congestion window is “6”, a space for one packet is formed. Therefore, the MEC server 300 may transmit a No. 8 packet (FIG. 12C).

On the other hand, FIGS. 13A to 13C illustrate an example in which the congestion window value is increased. Similar to FIG. 12A, it is assumed that the congestion window value is “6” and the MEC server 300 transmits six packets of No. 2 to No. 7 to the terminal 100 (FIG. 13A). Similar to FIG. 12B, when the MEC server 300 receives ACK for the No. 2 packet, the five packets of No. 3 to No. 7 are still being transmitted to the terminal 100 (FIG. 13B). As illustrated in FIG. 13B, it is also assumed that the MEC server 300 changes the congestion window value to “7”. In this case, the MEC server 300 may newly transmit two packets of No. 8 and No. 9. The No. 8 packet is a packet that may be transmitted even if the congestion window value is not changed. The No. 9 packet is a packet that may be transmitted by increasing the congestion window value by “1”.

Referring back to FIG. 9, for example, the terminal-communication management unit 320 performs processing described below. That is, the terminal-communication management unit 320 transmits the No. 8 packet as substitute for the one packet (referred to as an ACK-received packet) for which the ACK is received (S25). The terminal-communication management unit 320 increases the congestion window value “6” of the ACK-received TCP session by the update value W′ calculated in S21 (for example, an increment “1”) to a congestion window value “7” (S26). The terminal-communication management unit 320 transmits the No. 9 packet as an additional packet because the congestion window value is increased (S27).

For example, the terminal-communication management unit 320 increases the congestion window value of the ACK-received TCP session by the update value W′ to update the congestion window value and notifies the congestion window value after the update to the TCP-communication management unit 330 that manage the TCP session. The TCP-communication management unit 330 receives the notification and transmits the additional No. 9 packet.

The MEC server 300 terminates the process (S28).

When the congestion window value is equal to or larger than the target congestion window value after the update (No in S24), the MEC server 300 determines whether the congestion window value is larger than the target congestion window value after the update (S30).

When the congestion window value is larger than the target congestion window value after the update (Yes in S30), the MEC server 300 performs processing in S31 to S34. In this case, the congestion window value of the ACK-received TCP session exceeds the target congestion window value after the update. Thus, the MEC server 300 performs the processing to reduce the congestion window value of the ACK-received TCP session to be equal to or smaller than the target congestion window value (S31).

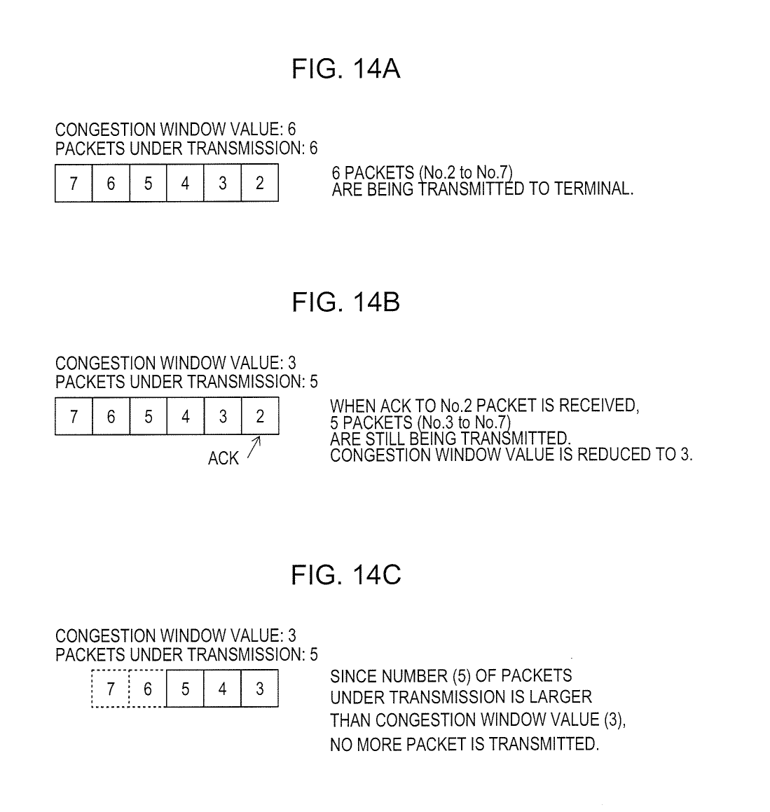

In order to describe the processing in S31, an example illustrated in FIGS. 14A to 14C is described. Similar to FIG. 12A, it is assumed that the congestion window value is “6” and the MEC server 300 transmits six packets of No. 2 to No. 7 to the terminal 100 (FIG. 14A). Similar to FIG. 12B, when the MEC server 300 receives ACK for the No. 2 packet, the five packets of No. 3 to No. 7 are still being transmitted to the terminal 100 (FIG. 14B). It is also assumed that the target congestion window value after the update is “4”. In this case, the congestion window value “6” exceeds the target congestion window value “4” after the update. The terminal-communication management unit 320 reduces the congestion window value from “6” to “3” smaller than the target congestion window value “4” (S31). Packets under transmission are five packets of No. 2 to No. 7. In this case, the terminal-communication management unit 320 transmits no more packet in the ACK-received TCP session (FIG. 14C).

In this case, the update value W′ for the congestion window of the ACK-received TCP session indicates an increase (Yes in S22). Therefore, the terminal-communication management unit 320 selects another TCP session (S32) and allocates the additional update value W′ to the selected other TCP session. The other TCP session is desirably a TCP session in which a congestion window value is smaller than the target congestion window value. If there are two or more such TCP sessions, the terminal-communication management unit 320 may split the update value W′ to be equally distributed to these TCP sessions.

For example, the terminal-communication management unit 320 increases the congestion window value of the selected TCP session by the update value W′ to update the congestion window value (S33) and notifies the congestion window value after the update to the TCP-communication management unit 330 that manages the selected TCP session. The TCP-communication management unit 330 receives the notification and transmits an additional packet (S34). For example, by using the example illustrated in FIG. 13C for the selected TCP session, the TCP-communication management unit 330 receives the notification and transmits the No. 9 packet as the additional packet.

The MEC server 300 terminates the process (S28).

When the congestion window value of the ACK-received TCP session is equal to the target congestion window value (No in S30), the MEC server 300 transmits new data as substitute for the ACK-received packet (S35). For example, in the example illustrated in FIGS. 12A to 12C, when the congestion window value is “6” and the terminal-communication management unit 320 receives ACK of the No. 2 packet, the terminal-communication management unit 320 transmits the No. 8 packet as substitute for the ACK-received packet. In this case, the terminal-communication management unit 320 does not increase the congestion window value of the ACK-received TCP session and updates the congestion window value to a value equal to the value before the ACK reception.

Subsequently, the MEC server 300 selects another TCP session (S36). According to S22, the congestion window value of the ACK-received TCP session may be increased. For example, the terminal-communication management unit 320 allocates the increment to the selected other TCP sessions rather than the TCP session. The other TCP session is desirably a TCP session in which a congestion window value is smaller than the target congestion window value.

The MEC server 300 increases the congestion window value of the selected TCP session (S37) and transmits data of an additional packet (S38). For example, the terminal-communication management unit 320 increases the congestion window value of the selected TCP session to update the congestion window value and notifies the congestion window value after the update to the TCP-communication management unit 330 that manages the selected TCP session. The TCP-communication management unit 330 receives the notification and transmits the data of the additional packet to the terminal 100.

The MEC server 300 terminates the process (S28).

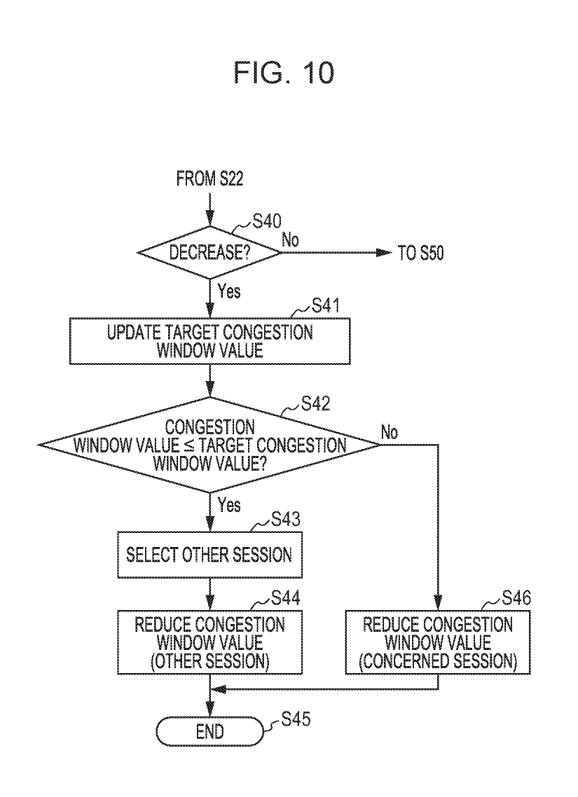

When the update value W′ for the congestion window does not indicate an increase (No in S22), the MEC server 300 determines whether the update value W′ indicates a decrease (S40 in FIG. 10). Depending on a congestion control algorithm, even if ACK is received, it is sometimes determined that a packet loss has occurred when a considerable period has elapsed until the ACK is received after packet transmission or when a ratio of the number of ACK-received packets to the number of transmitted packets is lower than a threshold. In such a case, the congestion control algorithm causes the update value W′ for the congestion window to indicate a decrease. Taking into account the congestion control algorithm for determining that the packet loss has occurred and reducing the congestion window value, the MEC server 300 performs the determination in S40.

Upon determining that the update value W′ for the congestion window of the ACK-received TCP session indicates a decrease (Yes in S40), the MEC server 300 updates the target congestion window values (S41). The update of the target congestion window values is similar to the update of the target congestion window values in the case of the policy table 321 (S12 and S13 in FIG. 8). For example, when the update value W′ is “−10”, the terminal-communication management unit 320 distributes the update value W′ to three TCP sessions, that is, a TCP session of “user” and “foreground”, a TCP session of “user” and “background”, and a TCP session of “system” and “background”. Update values are respectively “−5”, “−4”, and “−1”. The terminal-communication management unit 320 adds the distributed update values to the “target congestion window values” in the terminal communication management information. For example, target congestion window values are “TW1−1”, “TW2−5”, and “TW3−4”.

Subsequently, the MEC server 300 determines whether the congestion window value of the ACK-received TCP session is equal to or smaller than the target congestion window value after the update (S42).

When the congestion window value is equal to or smaller than the target congestion window value (Yes in S42), the MEC server 300 selects another TCP session (S43). Since the update value W′ for a congestion window of the ACK-received TCP session indicates a decrease (Yes in S40), the congestion window value of the ACK-received TCP session is to be reduced. However, since the congestion window value before the reduction is equal to or smaller than the target congestion window value (Yes in S42), congestion has not occurred. Therefore, the congestion window value of the ACK-received TCP session does not have to be reduced. In this case, the MEC server 300 allocates the decremental update value W′ of the ACK-received TCP session to the selected other TCP sessions rather than the ACK-received TCP session. The other TCP session is desirably, for example, a TCP session in which a congestion window value exceeds the target congestion window value.

Thus, the MEC server 300 reduces the congestion window value of the selected TCP session (S44). For example, the terminal-communication management unit 320 reduces the congestion window value of the selected TCP session as indicated by the update value W′ to update the congestion window value and notifies the congestion window value after the update to the TCP-communication management unit 330 that manages the selected TCP session selected. In this case, for example, the terminal-communication management unit 320 keeps the congestion window value of the ACK-received TCP session at the congestion window value before the ACK reception and updates the congestion window value of the selected TCP session.

The MEC server 300 terminates the process (S45).

When the congestion window value is larger than the target congestion window value (No in S42), the MEC server 300 reduces the congestion window value of the ACK-received TCP session (S46). In this case, the congestion window value exceeds the target congestion window value after the update of the ACK-received TCP session. In such a case, the MEC server 300 reduces the congestion window value of the TCP session. For example, the terminal-communication management unit 320 reduces the congestion window value of the TCP session as indicated by the update value W′ to update the congestion window value and notifies the congestion window value after the update to the TCP-communication management unit 330 that manages the TCP session.

The MEC server 300 terminates the process (S45).

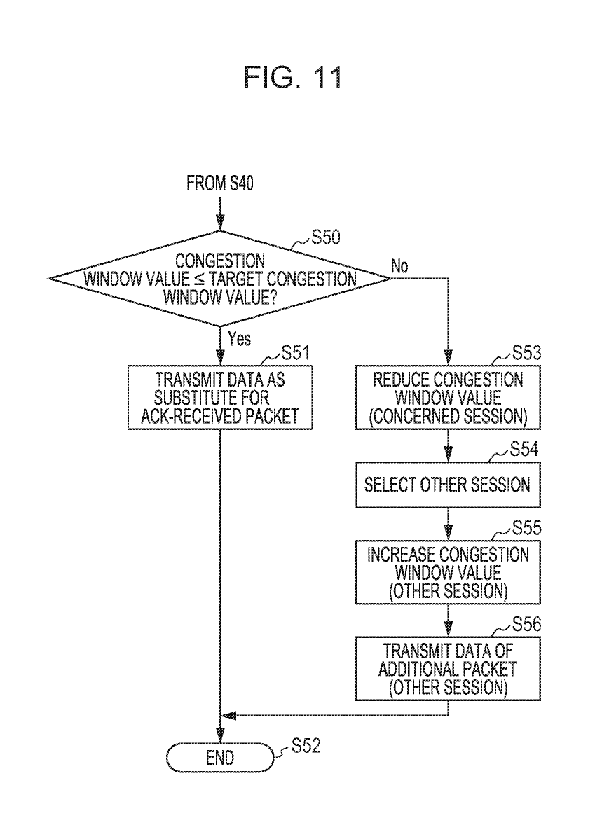

When the update value W′ for the congestion window of the ACK-received TCP session indicates no change (No in S40), the MEC server 300 determines whether the congestion window value of the TCP session is equal to or smaller than the target congestion window value (S50 in FIG. 11).

When the congestion window value is equal to or smaller than the target congestion window value (Yes in S50), the MEC server 300 transmits new data as substitute for the ACK-received packet (S51). For example, since the congestion window value of the TCP session is not changed, the terminal-communication management unit 320 transmits a packet as substitute for the ACK-received packet, as in the case illustrated in FIGS. 12A to 12C.

Referring back to FIG. 11, the MEC server 300 terminates the process (S52).

When the congestion window value is larger than the target congestion window value (No in S50), the MEC server 300 reduces the congestion window value of the ACK-received TCP session (S53). In this case, the update value W′ of the TCP session is “0”. Thus, the congestion window value of the TCP session is not to be changed. However, the congestion window value exceeds the target congestion window value. Therefore, the terminal-communication management unit 320 reduces the congestion window value such that the congestion window value of the TCP session is smaller than the target congestion window value.

Subsequently, the MEC server 300 selects another target TCP session (S54). For example, since the congestion window value of the ACK-received TCP session is reduced, the terminal-communication management unit 320 increases congestion window values of the selected other TCP session by the reduced amount to set the update values W′ to “0” as a whole. The other TCP session is desirably, for example, a TCP session in which a congestion window value is equal to or smaller than the target congestion window value.

Thus, the MEC server 300 increases the congestion window value of the selected TCP session by the amount reduced from of the congestion window value of the ACK-received TCP session in S53 (S55) and transmits data of an additional packet (S56). For example, the terminal-communication management unit 320 increases the congestion window value of the selected TCP session to update the congestion window value and notifies the congestion window value after the update to the TCP-communication management unit 330 that manages the selected TCP session. The TCP-communication management unit 330 receives the notification and transmits packets as many as a number corresponding to the increased congestion window value to the terminal 100, for example, as illustrated in FIGS. 13A to 13C.

Referring back to FIG. 11, the MEC server 300 terminates the process (S52).

A certain application 150 executed in the terminal 100 may end. In this case, information regarding the ended application 150 is deleted from the MEC server notification information and the terminal 100 transmits new MEC server notification information. The information regarding the ended application 150 is not included in the new MEC server notification information. In this case, when setting the target congestion window values (for example, FIG. 8), the MEC server 300 may use a congestion window value used in a TCP session for the deleted application 150. For example, the terminal-communication management unit 320 may distribute the congestion window value to congestion window values of other TCP sessions on the basis of the policy table 321 (or evenly). The terminal-communication management unit 320 may set the target congestion window values by, for example, performing the calculation of the sum (S11) on the basis of the distributed congestion window values after the update.

### Second Embodiment

A second embodiment is described. For example, the terminal 100 may generate information, which is included in the policy table 321 according to the first embodiment, and transmit the information to the MEC server 300 as MEC server notification information.

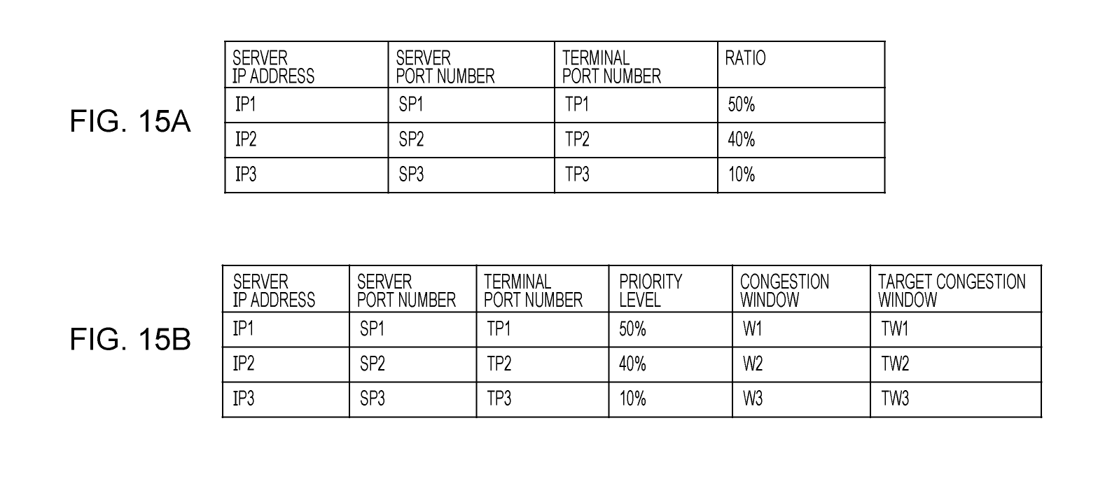

FIG. 15A illustrates an example of the MEC server notification information. The MEC server notification information includes information on a ratio instead of the state and the type of the application 150 in the first embodiment (for example, FIG. 4C). For example, the application management unit 120 or the communication management unit 130 may set a ratio for each of the TCP sessions for the applications 150-1 to 150-3 and generate MEC server notification information including the set ratio. In this case, the MEC server notification information including the ratio is set, for example, for each of the applications 150-1 to 150-3. Therefore, for example, as in the first embodiment, it may be considered that the MEC server notification information including the ratio includes application information on the applications 150-1 to 150-3 executed in the terminal 100.

In this case, the MEC server 300 receives the MEC server notification information transmitted from the terminal 100 and generates or updates terminal communication management information. FIG. 15B illustrates an example of the terminal communication management information. The terminal communication management information includes a “priority level” for each of the TCP sessions. The “priority level” corresponds to the ratio included in the MEC server notification information. The terminal-communication management unit 320 generates or updates the terminal communication management information illustrated in FIG. 15B by, for example, storing the terminal communication management information in the memory on the basis of the MEC server notification information. Thereafter, as in the first embodiment, for example, upon receiving ACK in a certain TCP session, the terminal-communication management unit 320 sets target congestion window values on the basis of the “priority level”. The terminal-communication management unit 320 adjusts congestion window values of the TCP sessions to bring the congestion window values close to the target congestion window values (for example, FIGS. 9 to 11).

According to the second embodiment, the MEC server 300 does not have the policy table 321 described in the first embodiment. Further, it is possible to achieve a reduction in processing, a reduction in a storage capacity of the memory, and the like.

In the first and second embodiments described above, the example is described in which the MEC server 300 performs the process for updating the target congestion window values and the process for adjusting the congestion windows. The update and the adjustment may be performed in, for example, the base station 200 and other communication apparatuses coupled to the mobile NW 500. Examples of the other communication apparatuses include a serving gateway (S-GW) and a packet data network gateway (P-GW) coupled to a mobile NW such as an LTE.

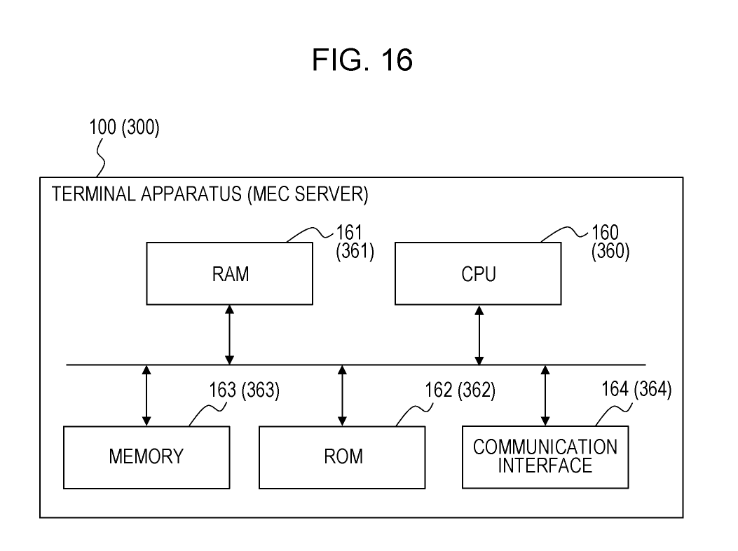

FIG. 16 illustrates an exemplary hardware configuration of the terminal 100. The terminal 100 illustrated in FIG. 16 may realize the functions and the process described in the first and second embodiments.

The terminal 100 includes a CPU 160, a random access memory (RAM) 161, a read-only memory (ROM) 162, a memory 163, and a communication interface 164.

The CPU 160 may execute the application management unit 120, the communication management unit 130, and the MEC-server linkage unit 140 by loading a computer program stored in the ROM 162 to the RAM 161 and executing the loaded computer program. The CPU 160 may also execute the applications 150-1 to 150-3 by executing the computer program. Therefore, the CPU 160 corresponds to, for example, the application management unit 120, the communication management unit 130, the MEC-server linkage unit 140, and the applications 150-1 to 150-3.

The memory 163 may store therein, for example, application information (for example, FIG. 4A), communication information (for example, FIG. 4B), and MEC server notification information (for example, FIG. 4C). The communication interface 164 corresponds to the communication interface 110 in the first embodiment.

FIG. 16 also illustrates an exemplary hardware configuration of the MEC server 300.

The MEC server 300 includes a CPU 360, a RAM 361, a ROM 362, a memory 363, and a communication interface 364.

The CPU 360 may realize the functions of the terminal-communication management unit 320 and the TCP-communication management units 330-1 to 330-3 described in the first embodiment by loading a computer program stored in the ROM 362 to the RAM 361 and executing the loaded computer program. The CPU 360 corresponds to, for example, the terminal-communication management unit 320 and the TCP-communication management units 330-1 to 330-3.

The memory 363 stores therein, for example, terminal communication management information (for example, FIG. 6) and the policy table 321 (for example, FIG. 7). The communication interface 364 corresponds to, for example, the communication interface 310 in the first embodiment.

Note that, for the CPUs 160 and 360, a controller or a processor such as a micro processing unit (MPU) or a field programmable gate array (FPGA) may also be used.

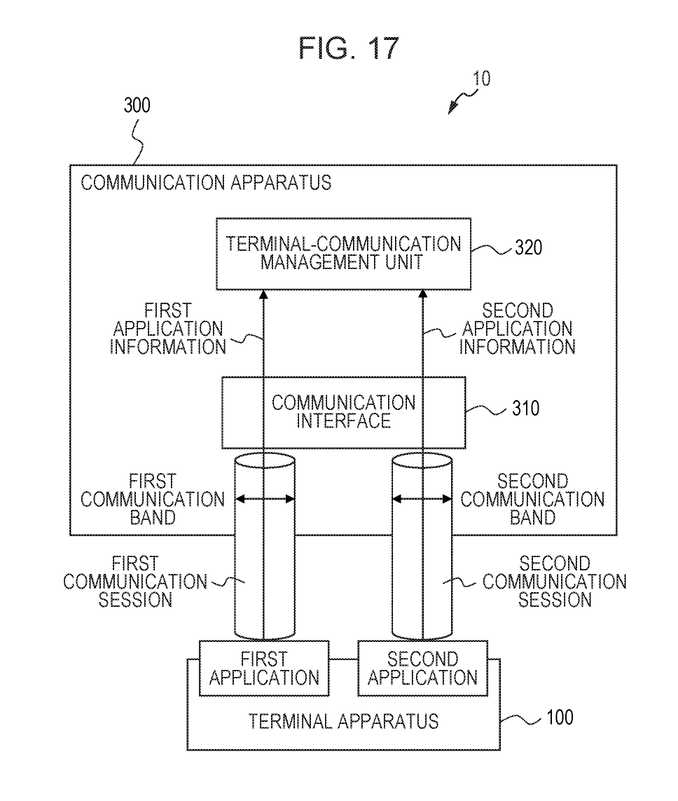

FIG. 17 is a diagram illustrating another exemplary configuration of the communication system 10. The communication system 10 includes a terminal apparatus 100 and a communication apparatus 300. The communication apparatus 300 corresponds to, for example, the MEC server 300 in the first and second embodiments.

The communication apparatus 300 includes the communication interface 310 and the terminal-communication management unit 320. The communication interface 310 receives, from the terminal apparatus 100, first application information on a first application executed in the terminal apparatus 100 and second application information on a second application executed in the terminal apparatus 100.

The terminal-communication management unit 320 controls, based on the first application information and the second application information, a first communication band for a first communication session corresponding to the first application and a second communication band for a second communication session corresponding to the second application.

For example, it is assumed that the first application is an application started by the user operating the terminal apparatus 100, and the second application is an application started without the user operating the terminal apparatus 100. The first application information and the second application information respectively include kinds of information indicating that the first and second applications are such applications. In this case, the terminal-communication management unit 320 may perform the distribution by treating the first communication band as a priority over the second communication band by controlling both of the first communication band and the second communication band on the basis of the first application information and the second application information.

In the terminal apparatus 100, compared with when such distribution is not performed, it is possible to achieve improvement of the throughput of communication for an application executed by operation of the user. Therefore, in the communication system 10, it is possible to improve sensory quality of the user.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus, comprising:
a memory; and
a processor coupled to the memory and the processor configured to:
receive application information on respective first and second applications from a terminal apparatus, the first and second applications being executed in the terminal apparatus; and
control first and second communication bands for respective first and second communication sessions on basis of the received application information, the first and second communication sessions corresponding to the respective first and second applications.

2. The communication apparatus according to claim 1, wherein
the application information includes a type of a relevant application and a state of the relevant application in the terminal apparatus

3. The communication apparatus according to claim 2, wherein
the type indicates whether the relevant application is a user application or a system application, the user application being executed by a user operation performed by a user on the terminal apparatus, the system application being executed without the user operation, and
the state indicates whether the relevant application is a foreground application or a background application, the foreground application being displayed at a foremost position on a display screen of the terminal apparatus and executed in a foreground where the user operation is allowed, the background application being executed without being displayed at the foremost position and executed in a background where the user operation is not allowed.

4. The communication apparatus according to claim 2, wherein
the processor is configured to:
set first and second target values for the respective first and second communication bands on basis of the types and the states of the respective first and second applications; and
control the first and second communication bands on basis of the respective first and second target values.

5. The communication apparatus according to claim 4, wherein
the processor is configured to:
set the first and second target values by distributing a total value of the first and second communication bands to the first and second target values on basis of the types and the states of the respective first and second applications.

6. The communication apparatus according to claim 5, wherein
the processor is configured to:
distribute the total value to the first and second target values on basis of a policy table including ratios for distributing the total value depending on a combination of the type and the state of the respective first and second applications.

7. The communication apparatus according to claim 4, wherein
the processor is configured to:
calculate an update value for updating a current value of the first communication band upon receiving an acknowledgment in the first communication session from the terminal apparatus;
update the first and second target values on basis of the update value; and
reduce, when the update value indicates an increase and when the current value is larger than the updated first target value, the first communication band to a value smaller than the first target value and increase the second communication band.

8. The communication apparatus according to claim 7, wherein,
the processor is configured to:
increase the second communication band as indicated by the update value when the update value indicates an increase and when the current value is larger than the updated first target value.

9. The communication apparatus according to claim 4, wherein
the processor is configured to:
calculate an update value for updating a current value of the first communication band upon receiving an acknowledgment in the first communication session from the terminal apparatus;
update the first and second target values on basis of the update value; and
increase the first communication band when the update value indicates an increase and when the current value is smaller than the updated first target value.

10. The communication apparatus according to claim 4, wherein
the processor is configured to:
calculate an update value for updating a current value of the first communication band upon receiving an acknowledgment in the first communication session from the terminal apparatus;
update the first and second target values on basis of the update value; and
maintain the first communication band and increase the second communication band when the update value indicates an increase and when the current value is equal to the updated first target value.

11. The communication apparatus according to claim 10, wherein,
the processor is configured to:
increase the second communication band as indicated by the update value when the update value indicates an increase and when the current value is equal to the updated first target value.

12. The communication apparatus according to claim 4, wherein
the processor is configured to:
calculate an update value for updating a current value of the first communication band upon receiving an acknowledgment in the first communication session from the terminal apparatus;
update the first and second target values on basis of the update value; and
maintain the first communication band and reduce the second communication band when the update value indicates a decrease and when the current value is equal to or smaller than the updated first target value.

13. The communication apparatus according to claim 12, wherein
the processor is configured to:
reduce the second communication band as indicated by the update value when the update value indicates a decrease and when the current value is equal to or smaller than the updated first target value.

14. The communication apparatus according to claim 4, wherein
the processor is configured to:
calculate an update value for updating a current value of the first communication band upon receiving an acknowledgment in the first communication session from the terminal apparatus;
update the first and second target values on basis of the update value; and
reduce the first communication band when the update value indicates a decrease and when the current value is larger than the updated first target value.

15. The communication apparatus according to claim 4, wherein
the processor is configured to:
calculate an update value for updating a current value of the first communication band upon receiving an acknowledgment in the first communication session from the terminal apparatus; and
reduce the first communication band and increase the second communication band when the update value indicates no update and when the current value is larger than the first target value.

16. The communication apparatus according to claim 4, wherein
the processor is configured to:
calculate an update value for updating a current value of the first communication band upon receiving an acknowledgment in the first communication session from the terminal apparatus; and
maintain the first communication band when the update value indicates no update and when the current value is equal to or smaller than the first target value.

17. The communication apparatus according to claim 1, wherein
the application information includes ratios for distributing a total value of the first and second communication bands to first and second target values for the respective first and second communication bands, and
the processor is configured to:
set the first and second target values on basis of the ratios.

18. The communication apparatus according to claim 1, wherein
the processor is configured to:
increase the second communication band by a value of the first communication band when the first application ends.

19. The communication apparatus according to claim 1, wherein
the first and second communication sessions are communication sessions by transmission control protocol (TCP), and
values of the first and second communication bands are congestion window values.

20. A communication method, comprising:
receiving, by a computer, application information on respective first and second applications from a terminal apparatus, the first and second applications being executed in the terminal apparatus; and
controlling first and second communication bands for respective first and second communication sessions on basis of the received application information, the first and second communication sessions corresponding to the respective first and second applications.
